(19) United States
(12) Patent Application Publication
(10) Pub. No.: US 2018/0145568 A1
(43) Pub. Date: May 24, 2018

(54) Commutation Device for Electrical Machine

(71) Applicant: SEG Automotive Germany GmbH, Stuttgart (DE)

(72) Inventor: Oliver CAPEK, Stuttgart (DE)

(21) Appl. No.: 15/817,681

(22) Filed: Nov. 20, 2017

(30) Foreign Application Priority Data
Nov. 21, 2016 (DE) 102016222924.9

(51) Int. Cl. H02K 13/10; H02K 7/20; H01R 39/04; H01R 39/18

(52) U.S. Cl. CPC H02K 13/10; H01R 39/18; H01R 39/04; H02K 7/20

(57) ABSTRACT

A commutation apparatus for an electric machine, having brushes with a front face which lies against the peripheral surface of a collector which has a plurality of collector segments separated by gaps, is designed in such a manner that a contact edge which runs obliquely to the gaps is formed on the front face of at least one brush.

The invention relates to a commutation apparatus for an electric machine, according to the preamble of claim 1.

### PRIOR ART

Commutation apparatuses are used for power transmission and for commutation on the armature winding of a rotating armature in electric machines. The commutation apparatus comprises a commutator rotor and/or collector on the armature, as well as carbon brushes on the peripheral surface of the collector. The collector is divided into individual collector segments distributed over the circumference, with gaps lying in between to electrically separate the collector segments. The winding wires of the armature windings are connected to the collector segments.

A commutation apparatus with brushes is known from DE 100 58 872 A1, wherein the brush edge thereof lying forward in the direction of movement runs obliquely relative to the segments and the segment gaps. This is intended to ensure that the brushes come gradually into contact with the following collector segment when the rotor shaft revolves, rather than the forward, obliquely oriented edge abruptly contacting the collector segment—with the intent to thereby reduce wear and the noise.

### DISCLOSURE OF THE INVENTION

The commutation apparatus according to the invention is used for power transmission and commutation in electric machines, particularly in internal rotor electric motors, such as electric starter motors of starting devices for internal combustion engines. This includes a use both in DC motors with permanent excitation and with electrical excitation.

The commutation apparatus comprises a commutator rotor and/or collector on the armature, connected to the rotor shaft of the electric machine and rotating together with the rotor shaft. Current is fed to coils of the armature, which is arranged on the rotor shaft, via the collector. The commutation apparatus further comprises a brush arrangement with a plurality of brushes, the front face of which is forced against the peripheral surface of the collector by spring force. The brushes are designed to conduct electricity—for example, as carbon brushes—wherein current is supplied to the collector, and then to the coils of the armature, via the brushes. The collector has a plurality of collector segments distributed over the circumference thereof, each of which is electrically connected to a coil. Adjacent collector segments are separated via a gap between the same.

At least one brush, and preferably all of the brushes, have a protruding contact edge on their front face which faces the collector, said contact edge running obliquely to the collector gaps between the collector segments. Current is transmitted from the brush to the collector via the contact edge, via which the brush has a correspondingly reduced contact with the peripheral surface of the collector. The contact edge extends on the front face of the brush, and has a reduced cross-sectional area relative to the entire front face.

Particularly when new brushes are used, the contact edge can ensure a defined contact with the collector. The contact edge forms a protrusion on the front face of the brush, such that the sections on the front face of the brush immediately adjacent to the contact edge have no contact with the collector. Overall, with new brushes, a desired, defined electrical behavior of the commutation apparatus and of the electric machine is achieved via the contact edge.

The contact edge runs obliquely to the gaps between the collector segments. Accordingly, the contact edge forms an angle with the gaps. In this case, designs can be contemplated in which the collector segments and the gaps run parallel to the rotor axis of the electric machine, as can designs with an oblique positioning of the collector segments and the gaps between them relative to the longitudinal axis of the rotor. The contact edges are sized—in particular with regard to their thickness, their length and their inclination relative to the gaps—in such a manner that the gaps are bridged by the contact edge during the rotation of the rotor shaft and the collector.

This design offers the advantage that the brush, which contacts the peripheral surface of the collector and is forced radially against the peripheral surface of the collector by the force of a spring element, cannot plunge into the gaps when the collector rotates. Rather, it assumes a constant radial position relative to the peripheral surface of the collector during the rotation. In this case, the contact edge is permanently in contact with the peripheral surface of the collector segments. There is no radial movement of the brush during the rotation of the collector. As such, the configuration prevents undesirable noise caused by the brush plunging into and/or being pushed back out of the gaps. This configuration also reduces the mechanical stress on the brush and on the collector.

With increasing operating time, the overlap length of the contact edge relative to the surrounding areas on the front face of the brush is reduced by wear, until the contact edge is worn away and the front face of the brush lies partially or completely flat against the peripheral surface of the collector. Regardless of the current degree of wear of the contact edge, it can bridge the gaps between the collector segments, thereby preventing the unwanted plunging movement into the gaps.

According to an advantageous embodiment, the contact edge is rectilinear. However, designs with a non-linear contact edge can also be contemplated—in particular, with a curved contact edge with constant or changing curvature.

According to a further expedient embodiment, the maximum width of the contact edge corresponds at most to the gap width of the gaps. Despite this relatively narrow width of the contact edge, the oblique orientation ensures that the gaps are bridged by the contact edge in any angular position of the collector relative to the brushes.

According to a further expedient embodiment, the contact edge forms a minimum angle with the gaps of at least 10°, or at least 20°, by way of example. According to yet another expedient embodiment, the contact edge forms a defined maximum angle with the gaps of at most 30°, by way of example.

According to yet another expedient embodiment, the contact edge is constructed integrally with the brush. The contact edge is produced during the production of the brush, and forms a projecting, protruding extension on the front face of the brush. The entire front face of the brush can be composed of one, two or more oblique surfaces, wherein the contact edge is preferably formed at the intersection of two oblique surfaces.

According to yet another expedient embodiment, the brush has a rectangular cross-sectional area, wherein the contact edge runs diagonally or approximately diagonally on the front face of the brush. In the case of a diagonal extension, the contact edge has a maximum length on the front face of the brush. In the case of a diagonal arrangement of the contact edge on the front face of the brush, the longitudinal sides of the brush can run parallel to the gaps.

In an alternative embodiment, the contact edge extends parallel to the longitudinal sides of the rectangular brush, and particularly runs on the center of the front face of the brush. In this embodiment, the brush is oriented obliquely with respect to the collector segments and the gaps, such that the contact edge runs obliquely to the gaps.

According to yet another expedient embodiment, the brush is designed as a single-layer brush made of a single material. In an alternative embodiment, the brush is designed as a multi-layer brush which advantageously has a power layer and a commutation layer, which differ in particular in their electrical resistance. The contact edge can optionally run along the dividing line between the layers of the multilayer brush.

Further advantages and expedient embodiments can be found in the further claims, the description of the figures, and the drawings, wherein:

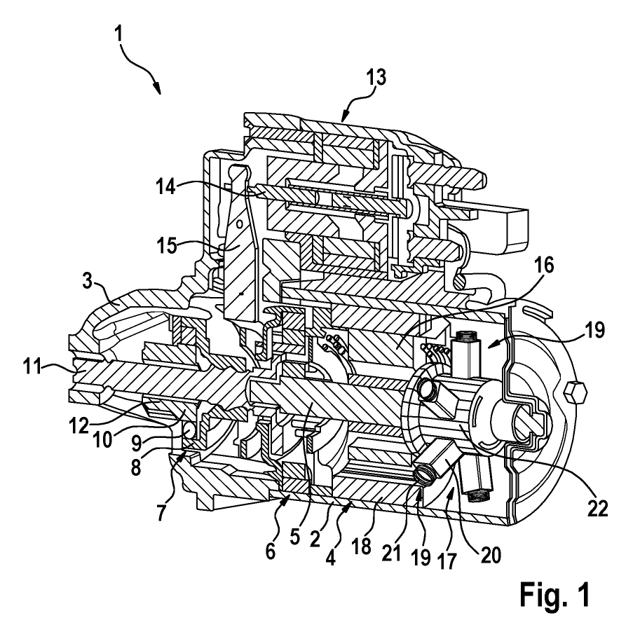

FIG. 1 shows a starting device for an internal combustion engine, in longitudinal section, having an electric starter motor with armature coils which are fed current via a commutation apparatus,

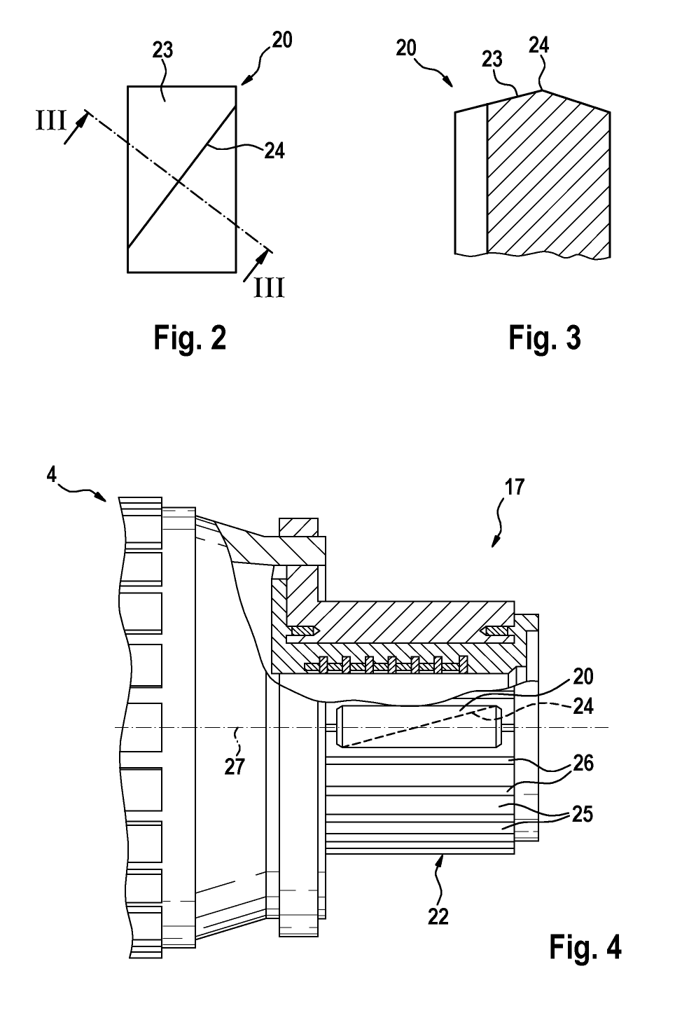

FIG. 2 shows a view of the front face of a brush of the commutation apparatus, with a contact edge which runs obliquely,

FIG. 3 shows a view of the brush according to section line III-III of FIG. 2,

FIG. 4 shows a commutation apparatus, having a brush with an obliquely oriented contact edge for bridging the gaps between adjacent collector segments,

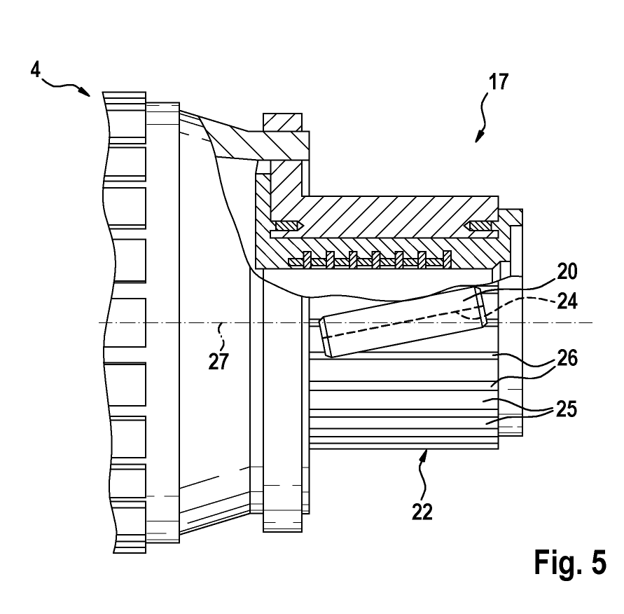

FIG. 5 shows an illustration, corresponding to FIG. 4, of a commutation apparatus, having an obliquely oriented brush with a rectilinear contact edge.

In the figures, the same components are indicated by the same reference numerals.

FIG. 1 shows a starting device 1 for an internal combustion engine, accommodating an electric starter motor 4 as the electric machine in a housing 2 which has a forward end plate 3. The rotor shaft 5 of the starter motor 4 drives, via a planetary gear 6, a drive shaft 11 on which a driver 8 of a freewheel device 7 is arranged in a manner allowing axial displacement, and is coupled to the drive shaft 11 in the direction of rotation. The driver 8 is supported via support rollers 9 on a roller collar 10, which is formed integrally with a starter pinion 12. Upon an axial advancement, the starter pinion 12 moves from a retracted, inoperative position into an advanced engagement position with the ring gear of an internal combustion engine.

The axial advancement of the starter pinion 12 is performed using an electromagnetic starter relay 13, which has an axially adjustable lifting armature 14 which is coupled to a forked lever 15. Upon an axial adjusting movement of the lifting armature 14, the fork lever 15 mounted on the housing is pivoted, thereby moving the driver 8, including the starter pinion 12, in the axial direction.

The electric starter motor 4 is designed as an internal rotor motor, and has an armature 16 which is connected to the rotor shaft 5 in a torque-proof manner and which contains electrically excitable armature coils. The coils in the armature 16 are energized via a commutation apparatus 17. The electromagnetic field generated by the electrical armature coils interacts with the magnetic field of permanent magnets 18 disposed on the inside of the stator which surrounds the armature.

The commutation apparatus 17 has a plurality of brush assemblies 19 configured as spring-brush units, each of which comprises, on the housing, a brush 20 formed as a carbon brush and a brush spring 21. The commutation apparatus 17 also comprises a collector 22 on the armature. The carbon brushes 20 are forced against the peripheral surface of the collector 22 by the brush springs 21. Carbon brushes 20 and brush springs 21 are suitably accommodated in brush holders which are fixed to the housing of the starter motor. A total of six spring-brush units 19 are evenly distributed over the circumference.

The collector 22 which rotates with the rotor shaft 5 comprises a plurality of brush segments electrically separated from each other via gaps. The brush segments, including the gaps between them, run parallel to each other and parallel to the rotor longitudinal axis of the electric machine 4.

FIG. 2 shows the front face of a brush 20 which is pressed radially against the peripheral surface of the collector by the force of a spring element. A contact edge 24 which protrudes beyond the front face 23, at least relative to the lateral edge region of the front face, is situated on the front face 23. The contact edge 24 thus forms the furthest-projecting extension on the front face 23. The contact edge 24 runs approximately diagonally on the front face 23 of the brush 20, which has a rectangular cross-sectional area. The contact edge 24 is formed integrally with the brush 20.

The contact edge 24 is constructed in a straight line on the front face 23, and forms an angle with respect to the longitudinal sides of the rectangular brush which is between a minimum angle and a maximum angle—for example, between at least 10° relative to the longitudinal side and a maximum of, for example, 30°.

FIG. 4 shows a section of an electric machine 4, having a commutation apparatus 17 which comprises the collector 22 rotating with the rotor shaft and a plurality of brushes 20, each of which is forced by a spring element radially towards the peripheral surface of the collector 22. The brushes 20 are designed as in the embodiment of FIGS. 2 and 3, and have a contact edge 24 which runs diagonally, which is designed as an extension, and is in contact with the collector segments 25. The collector segments 25 are separated from each other via gaps 26. The collector segments 25 and the gaps 26 run parallel to the rotor longitudinal axis 27.

The contact edge 24 on the front face bridges the gaps 26 due to the oblique orientation, such that in each position of the rotating collector 22 relative to a brush 20, the gap 26 is bridged and a portion of the contact edge 24 contacts a collector segment 25 which is adjacent to the bridged gap 26. This ensures that the brushes 20 do not plunge into the gaps 26 when the collector 22 rotates.

FIG. 5 shows an embodiment of a commutation apparatus 17 of an electric machine 4. In FIG. 5 as well, the brushes 20 have a projecting contact edge 24 which runs obliquely relative to the collector segments 25 and the gaps 26, and thereby bridges the gaps 26 in any rotational angle position of the collector 22. However, the contact edge 24 is aligned parallel to the longitudinal sides of the brush 20 with a rectangular cross-section, and runs centrally on the front face of the brush 20. The brush 20 is set obliquely overall, such that the longitudinal sides of the brushes 20 are at an angle to the gaps 26.

1. A commutation apparatus for an electric machine (4), having a brush arrangement (19) with a plurality of brushes (20), the front face (23) of which lies against the peripheral surface of a collector (22) which has a plurality of collector segments (25) separated by gaps (26), characterized in that a protruding contact edge (24) which runs obliquely to the gaps (26) between the collector segments (25) is formed on the front face (23) of at least one brush (20).

2. The commutation apparatus according to claim 1, characterized in that the contact edge (24) is rectilinear.

3. The commutation apparatus according to claim 1, characterized in that the brush (20) has a rectangular cross-sectional area and the contact edge (24) runs diagonally on the front face (23) of the brush (20).

4. The commutation apparatus according to claim 1, characterized in that the brush (20) has a rectangular cross-sectional area and the contact edge (24) runs parallel to the longitudinal sides of the brush (20).

5. The commutation apparatus according to claim 1, characterized in that the longitudinal sides of the brush (20) with a rectangular cross-sectional area run parallel to the gaps (26).

6. The commutation apparatus according to claim 1, characterized in that the longitudinal sides of the brush (20) with a rectangular cross-sectional area run obliquely to the gaps (26).

7. The commutation apparatus according to claim 1, characterized in that the collector segments (25) and the gaps (26) run parallel to the rotor longitudinal axis (27) of the electric machine (4).

8. The commutation apparatus according to claim 1, characterized in that the contact edge (24) is formed integrally with the brush (20).

9. The commutation apparatus according to claim 1, characterized in that the contact edge (24) forms an angle with the gaps (26) of at most 30°.

10. The commutation apparatus according to claim 1, characterized in that the width of the contact edge (24) corresponds to at most the gap width of the gaps (26).

11. The commutation apparatus according to claim 1, characterized in that the angle of the contact edge (24) relative to the gaps (26) is dimensioned so that the contact edge (24) bridges the gaps (26).

12. An electric machine, in particular a starter motor, having a commutation apparatus (17) according to claim 1.
